(19) United States
(12) Patent Application Publication
(10) Pub. No.: US 2007/0043722 A1
(43) Pub. Date: Feb. 22, 2007

(54) Classification system

(76) Inventors: Brian MacNamee, Dublin (IE); Gareth Bradshaw, Rathgar (IE); John (Sean) Doherty, Dublin (IE); James Mahon, Glasnevin (IE); Richard Evans, Rathmines (IE)

Correspondence Address: PERMAN & GREEN, 425 POST ROAD, FAIRFIELD, CT, 06824, US

(21) Appl. No.: 11/405,211

(22) Filed: Apr. 17, 2006

(30) Foreign Application Priority Data
Aug. 22, 2005 (GB) 0517112.9

(51) Int. Cl. G06F 7/00; G06N 5/02

(52) U.S. Cl. 707/7; 706/48

(57) ABSTRACT

A classification system automatically generates an indication that a training feature vector case is a pollutant based on a mis-labelled reference image. It excludes the case from the set, builds a k-nearest neighbour confidence classifier, and then classifies the case using this classifier. The case may be marked as suspect if its classification does not match what is determined, or if they do match, if the confidence level is below a threshold. The system can automatically remove or re-label all suspect cases.

### INTRODUCTION

The invention relates to a classification system for machine vision inspection.

Machine inspection problems often rely on classifiers trained using feature vectors extracted from labelled images. The veracity of these labels is usually reliant upon human operators and so can often be inaccurate—particularly when large amounts of data are involved. Using a feature vector extracted from a mislabelled image to train a classifier can be catastrophic. For example, an image of a defective solder joint might be labelled as being of an acceptable joint and an extracted feature vector might be used to train a classifier for the purpose of catching solder joint defects. The resultant classifier would likely pass subsequently inspected defective joints due to their similarity to the pollutant case.

The problem of pollutant cases can be illustrated by considering a data set in which each case has just two features. A plot of such a set of cases is shown in Fig. A, in which good cases are shown as squares and bad cases as circles. In the situation shown two pollutant cases have been added to the training set—the two squares shown in the cluster of circles to the right of the graph. The problem of pollutant data is illustrated through the inclusion of a query case (shown as a cross in the graph) which is a genuine example of the bad class. Although this case lies almost directly in the middle of the cluster of bad examples, its proximity to the two pollutant cases may lead it to be classified as a member of the good class.

A further example of a similar graph from a prototype application is shown in Fig. B. In this case the classification task seeks to distinguish between present and absent electronic components on a printed circuit board. Again a plot of two of the available features is shown. The cases to the top of the graph are the examples of absent components while those towards the bottom of the graph are examples of present components. The highlighted case (and that shown in the image to the right of the graph) is a pollutant case which has been labelled as an example of a present component, but is in fact an example of an absent component. This pollution will lead to poor classifier performance.

The invention addresses these problems.

### STATEMENTS OF INVENTION

According to the invention there is provided a classification system comprising a plurality of training feature vector cases based on reference samples, wherein the system comprises a pollutant identification means for automatically generating an indication if a case is a pollutant case arising from a mis-labelled reference sample.

In one embodiment, the pollutant identification means comprises means for:
removing a case from the set of cases,
building a classifier from the remaining cases, and
using said classifier to classify the case.

In another embodiment, the pollutant identification means is operable to generate a confidence value representing confidence that the case is classified as a pollutant or not a pollutant.

In a further embodiment, the classifier is operable to generate said confidence value.

In one embodiment, the classifier is a k-nearest neighbour classifier.

In another embodiment, the pollutant identification means comprises means for inverting the confidence value if it determines that the original classification of the case is incorrect.

In a further embodiment, the pollutant identification means is operable to repeat a process for generating an indication of likelihood of a case being a pollutant for every case in turn.

In one embodiment, the cases are tagged according to the process outcome.

In another embodiment, the system comprises an interactive tool for:
generating a display of data concerning cases identified as potentially being pollutants; and
prompting user input of a confirmation of case status.

In a further embodiment, the interactive tool is operable to automatically display an image of a reference sample used for a case which is identified as a potential pollutant.

In one embodiment, the tool is operable to display the image alongside the case data.

In another embodiment, the cases are for circuit boards.

In another aspect the invention provides a machine vision system for inspection of circuit boards, the system comprising any classification system as defined above.

### DETAILED DESCRIPTION OF THE INVENTION

The invention will be more clearly understood from the following description of some embodiments thereof, given by way of example only with reference to the accompanying drawings in which:

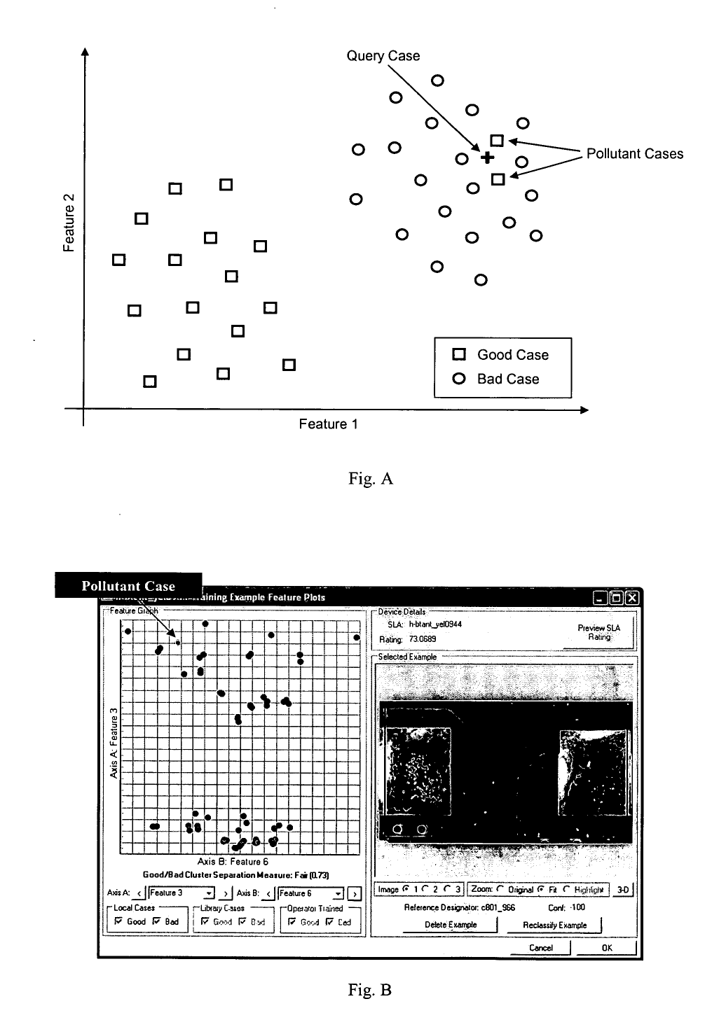

FIG. 1 is a flow diagram of a process for identifying pollutant cases in a classification system;

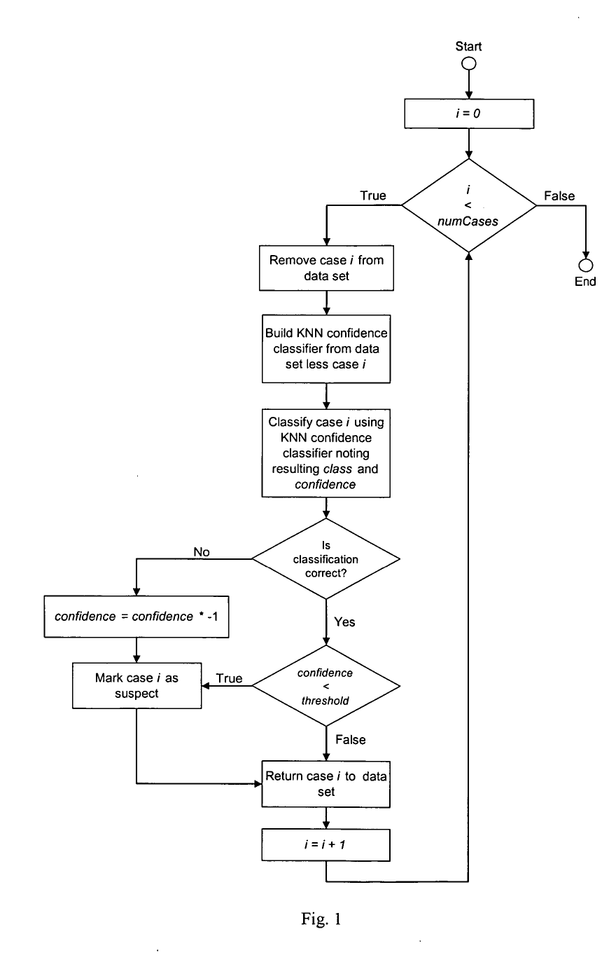

FIG. 2 is a sample screenshot illustrating a display generated by the system when a potential pollutant case is identified; and

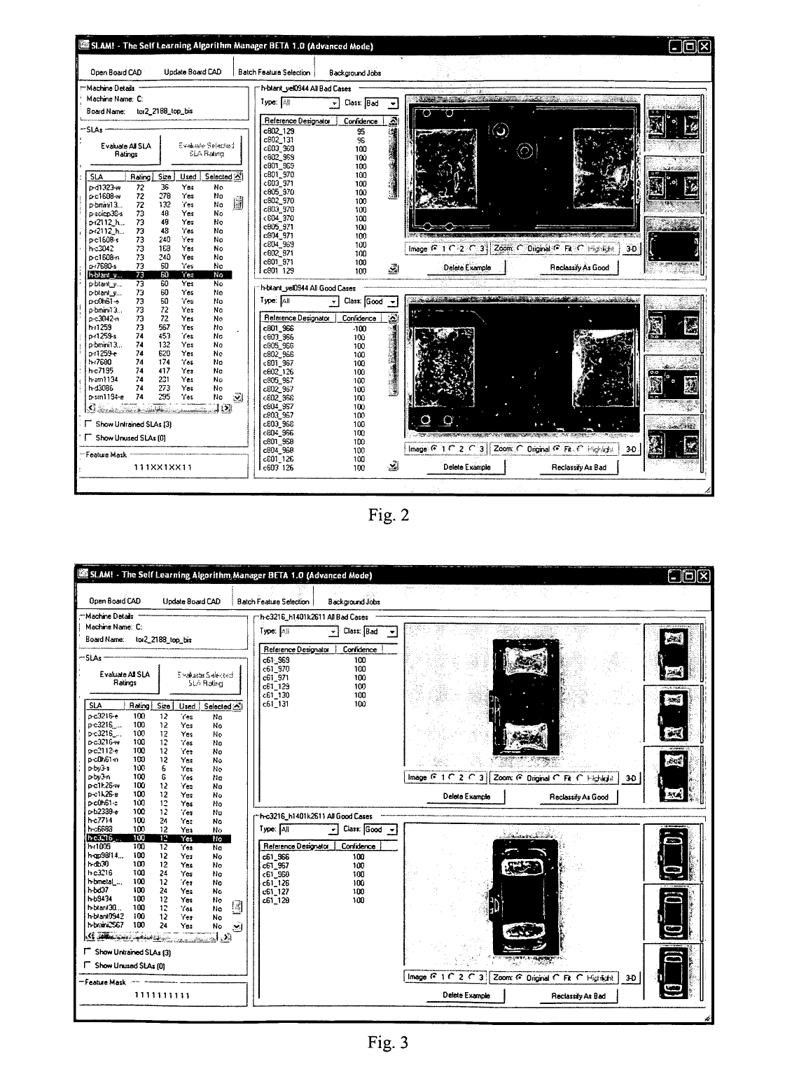

FIG. 3 is a screenshot for an example in which there is no pollutant case.

Referring to FIG. 1, there are i cases in a classification system, each case being a feature vector which is derived from a good or bad sample image. The method of FIG. 1 identifies potential pollutant cases.

For each case i in turn, it is removed from the data set of the classification system. While the case is removed, the system builds a k-nearest neighbour confidence classifier. It then classifies the particular case i using the classifier built in the preceding step. This classification results in a predicted class for the query case and a confidence in this prediction which is based on the similarity of the query case to its nearest neighbours.

In the next step the system compares the classification originally assigned to the case with that which was determined in the preceding step.

If the predicted classification matches the classification originally assigned to the case the confidence value is compared with a pre-determined threshold. If above the threshold, the case is not suspect and it is returned to the data set. If the confidence value is below the threshold, the case is marked as suspect before being returned to the data set.

In another branch, if the classifications do not match, the confidence value is inverted so that it reflects a confidence of this decision, i.e. that the case is a pollutant. This case is marked as suspect before being returned to the data set.

Upon processing of all cases i, the entire data set is given a rating to indicate its level of pollution, and each feature vector is given a rating to indicate the likelihood that it is a pollutant case.

Once examination is complete the tool presents its results to a user in such a way that those feature vectors which are most likely to be pollutant cases, along with the images from which they were extracted, are highlighted. Displaying the images upon which a feature vector is based enables a user to confirm or refute its status as a pollutant case. Pollutant cases can be removed from a data set or they can be simply relabelled.

After they have been rated, a list of all of the cases in a data set, ordered by their ratings, are presented to a user along with the images from which the cases were extracted. By ordering the list, those cases which are likely to be pollutants are brought immediately to a user's attention. To confirm or refute a case's status as a pollutant a user simply examines the image from which the features in the case were extracted, displayed next to the case. If a case really is a pollutant then it can be removed entirely from the data set or reclassified.

Rather than requiring the intervention of a user, the system can alternatively automatically remove all suspect pollutant cases from a data set if instructed to do so.

Dealing with pollutant cases in a data set will result in the creation of more accurate classifiers.

Rating Cases

In more detail, the likelihood of an individual case being a pollutant is calculated by performing a series of leave-one-out cross validations. Leave-one-out cross validation performs a mock classification on every case within a data set. Each case is classified using a classifier trained with all of the remaining cases. The classifier used is a variant of the k-nearest-neighbour algorithm which, rather than simply producing a classification, produces a classification and a confidence in that classification.

Rating Data Sets

The ratings of the individual cases within a data set can be combined to give the data set itself an overall rating. Many different combination functions can be used for this, with an average of the individual case ratings being the most obvious.

Presenting Results to a User

Screenshots are shown in FIGS. 2 and 3. In each screenshot the list to the left of the screen shows the data sets being considered for cleaning by the tool with their associated ratings. In FIG. 2 a data set featuring a pollutant case has been selected which leads to the display of all of the cases in that data set, along with their associated ratings. These cases are displayed in two lists—the one to the top of the screen containing the bad examples and the one to the bottom of the screen containing the good examples. At the top of the list of good examples a case has been given a rating of −100 indicating a strong likelihood that it is a pollutant case. This is confirmed by the image to the right of the list which shows the image corresponding to this case clearly depicting an absent component. By highlighting the possible pollution the system allows a user to easily correct the situation either by removing the pollutant case from the data set entirely, or reclassifying it as an example of an absent component.

For comparison, FIG. 3 shows a screenshot of the same application with a data set selected which contains no pollution. In this example all training cases have been given high ratings by the system, indicating that the data set is clear of pollution.

Cleaning a Data Set

Based on inspection of those cases which the system determines are likely to be pollutants, users can choose to take action to clean the data set. Pollutant cases can either be deleted from a data set, reclassified or retained—indicating that they are not in fact pollutant cases.

Automatically Cleaning a Data Set

Rather than requiring human intervention, the system can automatically remove all suspect pollutant cases from a data set. Although this will have the effect of cleaning a data set, it may remove some valid cases which have been incorrectly suspected of being pollutants.

The invention is not limited to the embodiments described but may be varied in construction and detail.

1. A classification system comprising a plurality of training feature vector cases based on reference samples, wherein the system comprises a pollutant identification means for automatically generating an indication if a case is a pollutant case arising from a mis-labelled reference sample.

2. A classification system as claimed in claim 1, wherein the pollutant identification means comprises means for:
removing a case from the set of cases,
building a classifier from the remaining cases, and
using said classifier to classify the case.

3. A classification system as claimed in claim 2, wherein the pollutant identification means is operable to generate a confidence value representing confidence that the case is classified as a pollutant or not a pollutant.

4. A classification system as claimed in claim 3, wherein the classifier is operable to generate said confidence value.

5. A classification system as claimed in claim 4, wherein the classifier is a k-nearest neighbour classifier.

6. A classification system as claimed in claim 4, wherein the pollutant identification means comprises means for inverting the confidence value if it determines that the original classification of the case is incorrect.

7. A classification system as claimed in claim 1, wherein the pollutant identification means is operable to repeat a process for generating an indication of likelihood of a case being a pollutant for every case in turn.

8. A classification system as claimed in claim 7, wherein the cases are tagged according to the process outcome.

9. A classification system as claimed in claim 1, wherein the system comprises an interactive tool for:
generating a display of data concerning cases identified as potentially being pollutants; and
prompting user input of a confirmation of case status.

10. A classification system as claimed in claim 9, wherein the interactive tool is operable to automatically display an image of a reference sample used for a case which is identified as a potential pollutant.

11. A classification system as claimed in claim 10, wherein the tool is operable to display the image alongside the case data.

12. A classification system as claimed in claim 1 wherein the cases are for circuit boards.

13. A machine vision system for inspection of circuit boards, the system comprising a classification system of claim 1.
